(19) United States
(12) Patent Application Publication
(10) Pub. No.: US 2016/0049147 A1
(43) Pub. Date: Feb. 18, 2016

(54) DISTRIBUTED VOICE INPUT PROCESSING BASED ON POWER AND SENSING

(71) Applicant: Glen J. Anderson, Beaverton, OR (US)

(72) Inventor: Glen J. Anderson, Beaverton, OR (US)

(21) Appl. No.: 14/459,117

(22) Filed: Aug. 13, 2014

(51) Int. Cl. G10L 15/22; G06F 3/16; G06F 1/32; G10L 25/60; G10L 15/30

(52) U.S. Cl. CPC G10L 15/22; G10L 25/60; G10L 15/30; G06F 1/3234; G06F 3/167; G10L 2015/223

(57) ABSTRACT

Techniques to coordinate the processing of audio in a distributed audio processing system are described. A power preferred computing device includes an audio processing coordinator to coordinate the capture and processing of audio signals by the power preferred device and secondary computing devices in a network. The network may be a personal area network. The audio processing coordinator may wake secondary devices to capture or process audio based on determinations that the power preferred device is not adequate to capture or process the audio.

### BACKGROUND

Modern clothing and other wearable accessories may incorporate computing or other advanced electronic technologies. Such computing and/or advanced electronic technologies may be incorporated for various functional reasons or may be incorporated for purely aesthetic reasons. Such clothing and other wearable accessories are generally referred to as “wearable technology” or “wearable computing devices.”

As can be appreciated, power consumption for wearable technology is of a prime concern. As such, some wearable technologies include energy harvesting features. For example, piezo-electric devices, solar cell devices, kinetic devices, or the like may be used to harvest energy and power the electronic components or charge a power source included within wearable technology.

Due to a variety of factors, the types of wearable technology suitable for use with energy harvesting devices can be limited. For example, a shoe is an optimal wearable item to incorporate energy harvesting devices into due to the forces involved in walking and running. However, a shoe may not be an optimal location for certain other electronic technologies. For example, normal usage of the shoe may cause interference with audio capture or processing technologies.

Accordingly, it can be problematic to incorporate certain electronic technologies for supporting desired features and provide energy harvesting into the same wearable device. It is with respect to the above, that the present disclosure is provided.

### BRIEF DESCRIPTION OF THE DRAWINGS

FIG. 1 illustrates an embodiment of an audio processing system.

FIGS. 2-3 illustrate examples of portions of the audio processing system of FIG. 1.

FIGS. 4-5 illustrate examples of logic flows according to embodiments.

FIG. 6 illustrates a storage medium according to an embodiment.

FIG. 7 illustrates a processing architecture according to an embodiment.

### DETAILED DESCRIPTION

Various embodiments are generally directed to a system where one device in the system is designated as a power preferred device. The system may be comprised of multiple devices organized in a network, such as, a personal area network (PAN). In general, the power preferred device listens for audio input (e.g., audio signals, voice commands, or the like). Upon receipt or detection of audio input, the power preferred device can (i) process the audio itself or (ii) instruct another device in the system to process the audio. For example, the power preferred device, upon detection of an audio signal, can both capture the audio signal and wake a secondary device to also capture the audio. Then depending upon the quality of the audio captured by the power preferred device, the power preferred device may process the audio or may instruct the secondary device to process the audio.

It is to be appreciated, that this is one example of the present disclosure and that other examples are described herein. As such, the above general description is not intended to be limiting.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

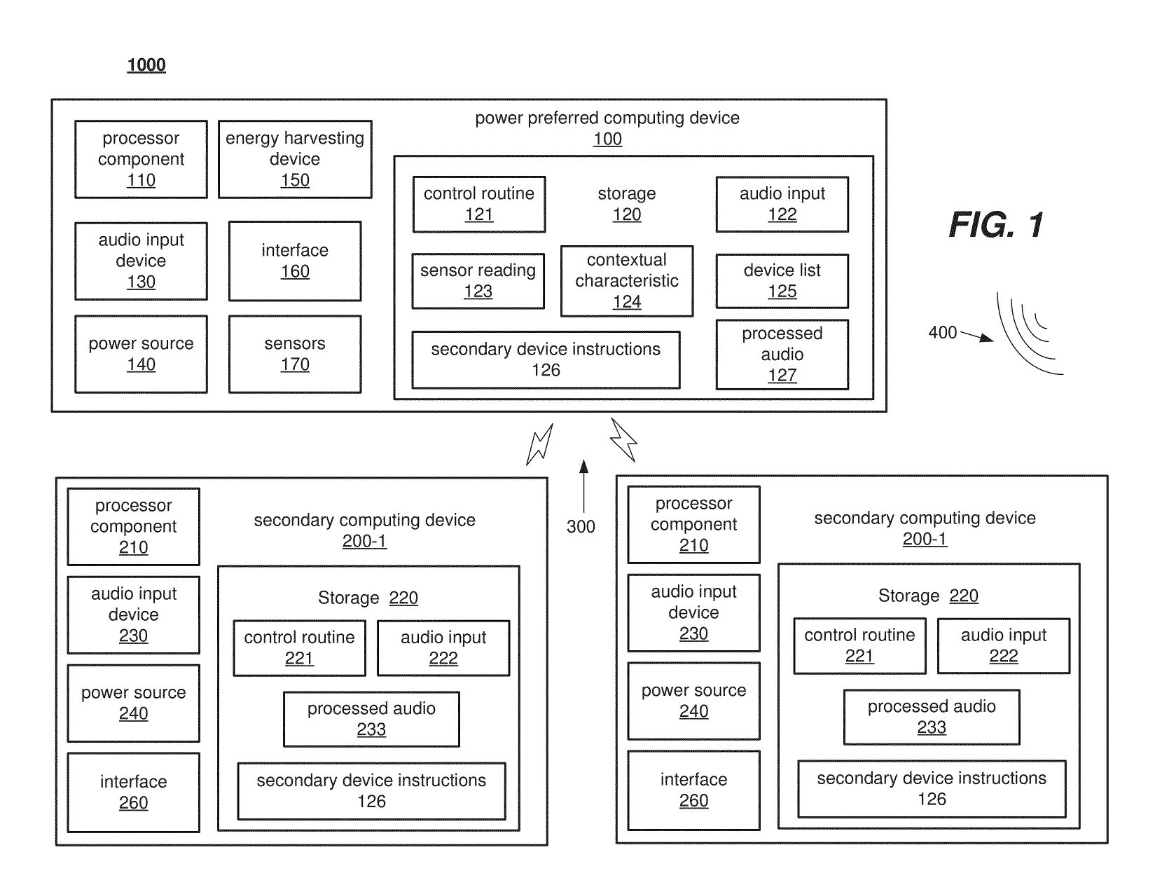

FIG. 1 is a block diagram of an embodiment of an audio processing system 1000 incorporating a power preferred computing device 100 and a number of secondary computing devices 200-a, where a is a positive integer. As depicted, two secondary computing devices 200-1 and 200-2 are shown. It is to be appreciated, that the number of secondary computing devices 200-a is shown at a quantity to facilitate understanding and is not intended to be limiting. In particular, the system 1000 can be implemented with more or less secondary computing devices than depicted. Furthermore, it is important to note, that although the power preferred computing device 100 is depicted as different (e.g., including at least one different component) than the secondary devices 200-1 and 200-2, in some examples, the devices 100, 200-1, and 200-2 may be identical. In such examples, as described in greater detail below, one of the devices in the system may elect to be or may be assigned the role of the “power preferred computing device.” As used herein, the “power preferred computing device” means the device that coordinates audio processing as described herein.

In general, the power preferred computing device 100 is depicted configured to detect an audio signal and coordinate the processing of the audio signal within the system 1000. In particular, the power preferred computing device 100 is configured to coordinate the processing of the audio signal such that power consumption among the secondary computing devices 200-1, 200-2 is minimized. In particular, the audio capture components or features of the power preferred computing device 100 may be active, while the audio capture components or features of the secondary devices 200-1 and 200-2 are inactive. Upon detection of an audio signal 400, the power preferred computing device 100 may “wake up” one or more of the secondary devices 200-1 and 200-2 in order to process the audio signal 400.

In various embodiments, the power preferred computing device 100 incorporates one or more of a processor component 110, a storage 120, an audio input device 130, a power source 140, an energy harvesting device 150, an interface 160, and sensors 170. The storage 120 stores one or more of a control routine 121, an audio input 122, a sensor reading 123, a contextual characteristic 124, a secondary device list 125, secondary device instructions 126, and processed audio 127.

In various embodiments, each of the secondary computing devices 200-1 and 200-2 incorporates one or more of a processor component 210, a storage 220, an audio input device 230, a power source 240 and an interface 260. Each of the storages 220 stores one or more of a control routine 221, an audio input 222, processed audio 223, and the secondary device instructions 126.

As depicted, the power preferred computing device 100 and the secondary computing devices 200-1 and 200-2 are operably connected via a network 300. In particular, the computing devices 100, 200-1, and 200-2 may exchange signals conveying information (e.g., wakeup information, audio processing instructions, or the like) through network 300. Additionally, the computing devices 100, 200-1, and 200-2 may exchange other data entirely unrelated to audio processing via the network 300. The computing devices 100, 200-1 and 200-2 may exchange signals, including audio processing information, with each other and with other computing devices (not shown) through network 300.

In various embodiments, the network 300 may be a single network possibly limited to extending within a single building or other relatively limited area, a combination of connected networks possibly extending a considerable distance, and/or may include the Internet. Thus, the network 300 may be based on any of a variety (or combination) of communications technologies by which signals may be exchanged, including without limitation, wired technologies employing electrically and/or optically conductive cabling, and wireless technologies employing infrared, radio frequency or other forms of wireless transmission. Furthermore, although the network 300 is shown as a wireless network, it may in some examples be a wired network.

In some examples, the network 300 may correspond to a PAN. For example, the network 300 may be a wireless PAN implemented according to one or more standards and/or technologies. In particular, the network 300 may be implemented according to IrDA, Wireless USB, Bleutooth, Z-Wave, or ZigBee technologies.

In the power preferred computing device 100, the control routine 121 incorporates a sequence of instructions operative on the processor component 110 in its role as a main processor component to implement logic to perform various functions. In executing the control routine 121, the processor component 110 receives (e.g., via the audio input device 130) the audio input 122. The audio input 122 may include an indication corresponding to the audio signal 400. In particular, in executing the control routine 121, the processor component 110 activates the audio input device 130 to listen for the audio signal 400.

The sensor reading 123 may correspond to one or more signals, readings, indications, or information received from the sensors 180. In some examples, the sensors 180 may include an accelerometer. In executing the control routine 121, the processing component 110 may receive output from the accelerometer and store the output as the sensor reading 123. The contextual characteristic 124 may correspond to a contextual characteristic related to the audio input. For example, if the sensor reading 123 corresponds to indications from an accelerometer, the contextual characteristic 124 may include an indication of an activity level (e.g., ranging between not moving and running, or the like). As another example, the contextual characteristic may include an audio quality (e.g., level of noise, or the like) corresponding to the audio input 122.

The secondary device list 125 includes a listing of the secondary devices 200-1 and 200-2 in the network 300. In some examples, as will be described in greater detail below, the list 125 may also include information related to a position of the devices 125 relative to the power preferred computing device 100, a position (e.g., mouth, or the like) of a user's body, an amount of available power, or the like.

The secondary device instructions 126 include indications of actions to be performed by one or more of the secondary devices 200-1 and 200-2. In particular, the secondary device instructions 126 include commands to “wake up” various components of the secondary devices 200-1 and/or 200-2. For example, the instructions 126 may include an instruction to wake up a main radio (e.g., communicated to a passive or low power radio, or the like). For example, the instructions 126 may include an instruction to wake up the audio input device 230 and capture the audio input 222 from the audio signal 400, instructions to process the audio input 222, instructions to process at least a portion of the audio input 222, instructions to deactivate the audio input device 230, or the like.

In executing the control routine 121, the processor component 110 determines whether to (i) capture the audio input 122, (ii) generate the processed audio 127 from the audio input 122, and/or (iii) instruct one or more of the secondary computing devices 200-1 and 200-2 to wake up, capture the audio input 222, and/or generate the processed audio 223 from the audio input 222.

It is worthy to note, that the secondary device instructions 126 may be directed to one or more of the secondary computing devices 200-1 and 200-2. In particular, the secondary device instructions 126 may be directed to one or more of the secondary computing devices 200-1 and 200-2 based on the secondary computing device list 125. For example, the instructions 126 may be directed to one of the secondary computing devices 200-1 or 200-2 that is indicated as more optimally placed (e.g., relative to the audio signal 400, or the like) than the power preferred computing device 100.

In each of the secondary computing devices 200-1 and 200-2, the control routine 221 incorporates a sequence of instructions operative on the processor component 210 in its role as a main processor component to implement logic to perform various functions. In executing the control routine 221, the processor component 210 receives the secondary device instructions 126. As described above, the secondary instructions 126 may include an instruction to wake up (or activate) the audio input device 230 to capture the audio input 222 from the audio signal 400 and/or to generate the processed audio 223 from the audio input 222.

In some examples, the power preferred computing device 100 and the secondary computing devices 200-1 and 200-2 may be any of a variety of types of devices including without limitation, a desktop computer system, a data entry terminal, a laptop computer, a netbook computer, a tablet computer, a handheld personal data assistant, a smartphone, a digital camera, a wearable computing device incorporated into clothing or wearable accessories (e.g., a shoe or shoes, glasses, a watch, a necklace, a shirt, an earpiece, a hat, etc.,) a computing device integrated into a vehicle (e.g., a car, a bicycle, a wheelchair, etc.), a server, a cluster of servers, a server farm, a station, a wireless station, user equipment, and so forth.

In various embodiments, the processor component 110 and/or the processor components 210 may include any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are in some way linked.

In various embodiments, the storage 120 and/or the storages 220 may be based on any of a wide variety of information storage technologies, possibly including volatile technologies requiring the uninterrupted provision of electric power, and possibly including technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, the audio input device 130 and/or the audio input devices 230 may be a microphone. In various embodiments, the power source 140 and/or the power sources 240 may be any of a variety of power sources (e.g., rechargeable batteries, or the like).

In various embodiments, the energy harvester 150 may be any of a variety of energy harvesting devices (e.g., kinetic energy capture devices, pizo-electric energy capture devices, solar cells, or the like).

In various embodiments, the interface 160 and/or the interfaces 260 may employ any of a wide variety of signaling technologies enabling computing devices to be coupled to other devices as has been described. Each of these interfaces may include circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ signaling and/or protocols conforming to any of a variety of industry standards, including without limitation, RS-232C, RS-422, USB, Ethernet (IEEE-802.3) or IEEE-1394. Where the use of wireless signal transmission is entailed, these interfaces may employ signaling and/or protocols conforming to any of a variety of industry standards, including without limitation, IEEE 802.11a, 802.11b, 802.11g, 802.11n, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1×RTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

In some examples, the interfaces 160 and 260 may include low power radios capable of being passive woken up. For example, the interfaces 160 and 260 may include radio-frequency identification (RFID) radios configured to operate in a low power state until activated, such as, for example, radios configured to operate in compliance with the Wireless ID and Sensing Platform (WISP)™. As described above, such radios may be configured to operate in accordance with any of a variety of different wireless technologies (e.g., Bluetooth, ANT, or the like).

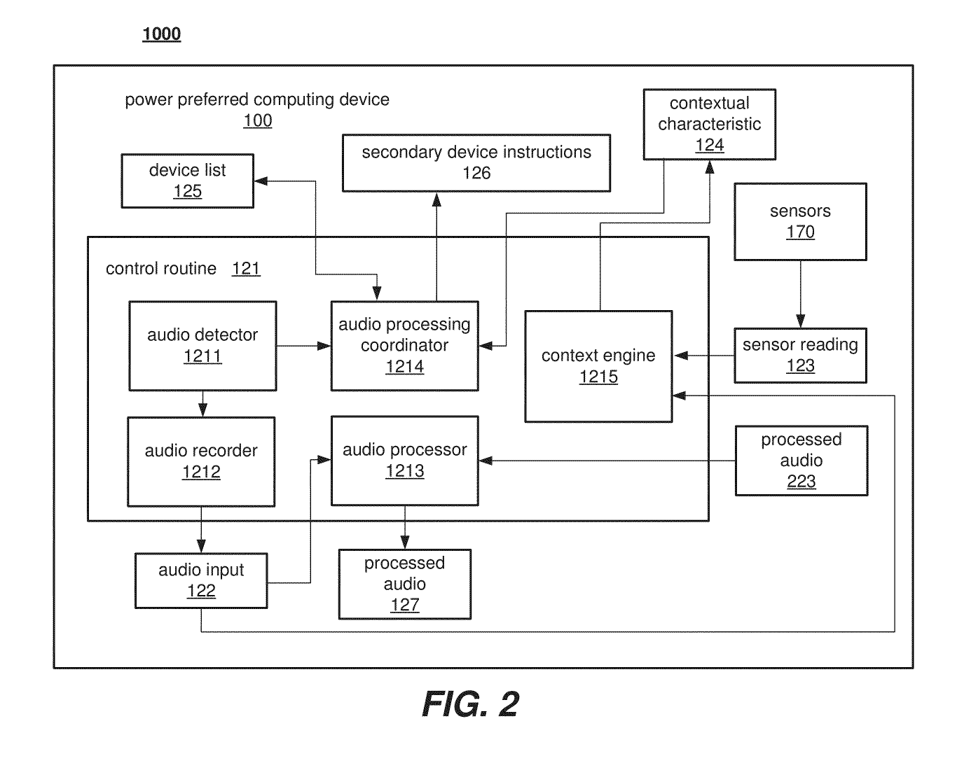

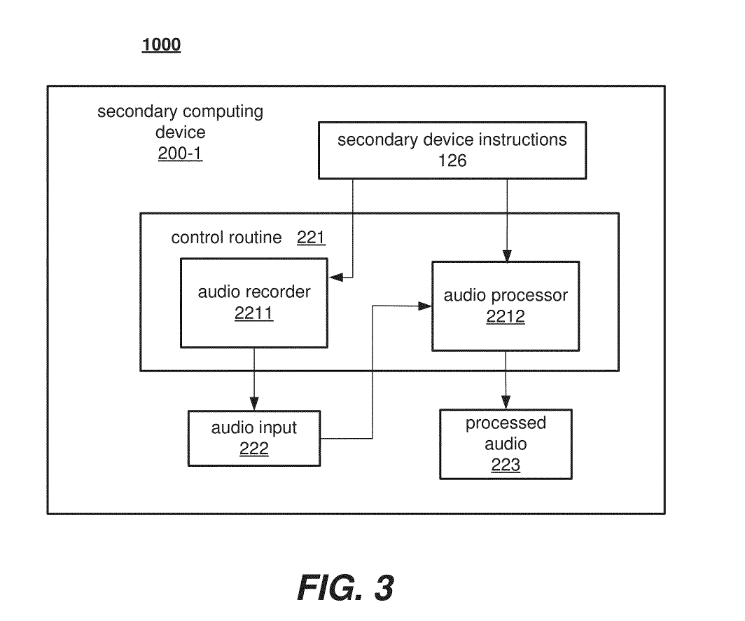

FIGS. 2-3 are block diagrams of portions of an embodiment of the audio processing system 1000 of FIG. 1. In general, FIGS. 2-3 illustrate aspects of the operation of the system 1000. In particular, FIG. 2 illustrates an embodiment of the power preferred computing device 100 configured to coordinate the capture and/or processing of the audio signal 400 while FIG. 3 illustrates an embodiment of the secondary computing device 200-1 configured to capture and/or process the audio signal 400 as directed by the power preferred computing device 100.

In various embodiments, the control routine 121 and/or the control routine 221 may include one or more of an operating system, device drivers and/or application-level routines (e.g., so-called “software suites” provided on disc media, “applets” obtained from a remote server, etc.). Where an operating system is included, the operating system may be any of a variety of available operating systems appropriate for whatever corresponding ones of the processor component 110 and/or 210. Where one or more device drivers are included, those device drivers may provide support for any of a variety of other components, whether hardware or software components, of the computer system 100 and/or 200.

Turning more specifically to FIG. 2, the control routine 121 includes an audio detector 1211, an audio recorder 1212, an audio processor 1214, an audio processing coordinator 1215, and a context engine 1216.

In general, the control routine 121 detects the audio signal 400 and coordinates the capture and processing of the audio signal 400 to preserve power consumed by the system 1000. In particular, the control routine 121 coordinates the capture (e.g., recording of the audio signal) and processing of the audio signal with one or more power sensitive devices (e.g., the secondary computing devices 200-1 and 200-2) that may have higher fidelity or more optimally placed audio input devices but that have greater power constraints than the power preferred computing device 100.

The audio detector 1211 detects the audio signal 400. The audio detector is operative on the audio input device 130 to detect audio signals 400. In some examples, the audio detector 1211 detects all audible signals 400. The audio recorder 1212 captures the audio signal 400 as the audio input 122. In general, the audio recorder 1212 saves the audio input 122 in storage 120, such that the audio input 122 includes indications of the audio signal 400. In various embodiments, the audio input can be any of a variety of file types or can be encoded using a variety of different audio encoding schemes (e.g., MP3, WAV, PSM, or the like). The audio processor. The audio processor 1213 processes the audio input 122 to generate the processed audio 127. In general, the audio processor 1213 may perform any of a variety of audio processing on the audio input 122. For example, the audio processor 1213 may perform voice recognition processing, noise filtering, audio quality enhancement, or the like.

The context engine 1215 generates the contextual characteristic 124. In some embodiments, the context engine 1215 is operably connected to the sensor 170 to receive input (e.g., sensor outputs) regarding conditions relative to the power preferred computing device. For example, with some embodiments, the sensor 170 is an accelerometer. Accordingly, the context engine 1215 may receive accelerometer output and determine an activity level corresponding to the power preferred computing device. In a particular example, the power preferred computing device may be implemented in a wearable computing device, such as, for example a shoe. As such, the context engine 1215 may determine whether the shoe is being worn, whether the shoe is being walked in, whether the shoe is being jogged in, or the like. The context engine 1215 may generate the contextual characteristic including an indication of this level of activity.

In some examples, the contextual characteristic corresponds to an audio quality of the audio input. In particular, the context engine 1215 may be operably coupled to the audio detector 1211, the audio recorder 1212 and/or the audio processor 1213 to receive indications of noise within the audio input 122, whether the audio input 122 could be processed by the audio processor 1213, whether portions of the audio input 122 could be processed, or the like. For example, for an audio input comprising periods between 1 through 10, the contextual characteristic may include an indication that the audio processor 1213 could not process periods 3 through 5. As another example, the contextual characteristic may include an indication of a level of noise (e.g., ambient noise, white noise, or the like) detected by the audio detector 1211.

In general, the audio processing coordinator 1214 determine whether to wake one of the secondary devices 200-1 or 200-2, whether to process the audio input 122 on the power preferred computing device (e.g., via the audio processor 1213), and also whether to instruct one of the secondary devices to process audio (e.g., refer to FIG. 3).

The audio processing coordinator 1214 is configured to determine whether to wake a secondary device and which secondary device to wake based on the contextual characteristics 124 and the device list 125. In general, the device list 125 may be generated by the audio processing coordinator. It may be dynamically updated during operation based on changing conditions within the system 1000. For example, the device list 125 may list active devices (e.g., power preferred devices 100, secondary devices 200, and the like). The device list 125 may also include indications of metrics related to each of the devices. For example, the device list 125 may include indications of the available power level of each of the devices, the audio input fidelity of each of the devices, the proximity to an audio source (e.g., a users mouth, or the like) of each of the devices.

In some examples, as indicated above, the contextual characteristic 124 includes an indication of an audio quality corresponding to the audio input 122. The audio processing coordinator 1214 may determine whether the audio quality (e.g., as reflected in the contextual characteristic 124) exceeds an audio quality threshold. Furthermore, the audio processing coordinator 1214 may determine to wake the secondary device (e.g., the secondary device 200-1 and/or 200-2) based on the determination that the audio quality does not exceed the audio quality threshold. The audio processing coordinator 1214 may determine not to wake the secondary device (e.g., the secondary device 200-1 and/or 200-2) based on the determination that the audio quality does exceed the audio quality threshold.

When the audio processing coordinator 1214 does wake the secondary computing device, audio processing coordinator 1214 generates one or more secondary device instructions 126. The secondary device instructions may include indications for the processor component 110 to operate on the network interface and transmit a wake up signal to the network interface corresponding to the secondary device to be woken up.

In some examples, as noted, the network interfaces (e.g., 160 and/or 260) may be passive radios (e.g., RFID radios, Bluetooth radios, ANT radios, or the like). Furthermore, in some examples, the network interfaces may include both a passive radio and a network radio. For example, the network interfaces may include an RFID radio and a Wi-Fi radio. Accordingly, the secondary device instructions may include an indication transmitted to the passive radio to wake up the network radio.

In some examples, the secondary device instructions 126 include an indication for the secondary device to turn on its audio input device and capture a secondary copy of the audio signal (e.g., refer to FIG. 3).

In some examples, the secondary device instructions 126 include an indication for the secondary device to process at least a portion of the secondary audio input. For example, as indicated above, the contextual characteristics 124 may include an indication that a portion of the audio input could not be processed or that a portion of the audio input had an audio quality that did not exceed an audio quality threshold. As such, the secondary device instructions 126 may include an indication to process a portion of the secondary audio input that corresponds to this portion of the audio input.

The audio processing coordinator may determine which secondary device to wake by selecting the secondary device with the greatest amount of available power, the device with the highest fidelity audio, the device most optimally placed with respect to the audio signal, and/or the like. In some examples, the audio processing coordinator 1214 may determine which secondary device to wake by balancing the fidelity of the audio input devices for each secondary device with the available power of each secondary device. For example, a device with a higher available power but lower audio input fidelity may be selected where the audio quality indicated by the contextual characteristic is not sufficiently low to preclude this particular secondary device from being used.

Additionally, the audio processor 2212 may receive processed audio (e.g., processed audio 223) from the secondary computing device 200. In some examples, the processed audio 223 may be combined with the processed audio 127. For example, if the processed audio 127 corresponds to a portion of the audio input 122 while the processed audio 223 correspond to a different portion of the audio input 222, the processed audio may be combined to form a more complete reconstruction of processed audio corresponding to the audio signal 400.

In some examples, the system 1000 may include a number of devices configured as the power preferred device 100. More specifically, the system 1000 may include multiple computing devices that include the control routine 121. In such an example, the audio processing coordinator 1214 may elect to be the power preferred device. As another example, the audio processing coordinator 1214 may assign another device within the system 1000 to be the power preferred device. For example, as indicated above, the device list 125 may include a list of available devices within the system 1000, their available power. Additionally, the device list may include indications of the features (e.g., whether the device includes an energy harvesting component, or the like) of the available devices. The device with the greatest amount of power and/or the device with a desired features (e.g., energy harvesting) can elect to be or may be assigned as the power preferred device.

Turning more specifically to FIG. 3, the control routine 221 includes an audio recorder 2211 and an audio processor 2212. In general, the control routine 221 receives the secondary device instructions 126 from the power preferred device 100. As described above, the secondary device instructions 126 may be transmitted by power on the secondary device through a passive radio. Once powered one, the secondary device instructions 126 may cause the device 200-a to record the audio signal 400. In particular, the secondary device instruction may include an instruction for the audio controller 2211 to record the audio input 222 from the audio signal 400. The audio input 222 may be referred to herein as the secondary audio input. The secondary device instructions 126 may also include an instruction for the audio processor 2212 to process as least a portion of the audio input 222, resulting in the processed audio 223. Furthermore, the secondary device instructions 126 may include instructions to transmit the processed audio 223 to the power preferred computing device 100.

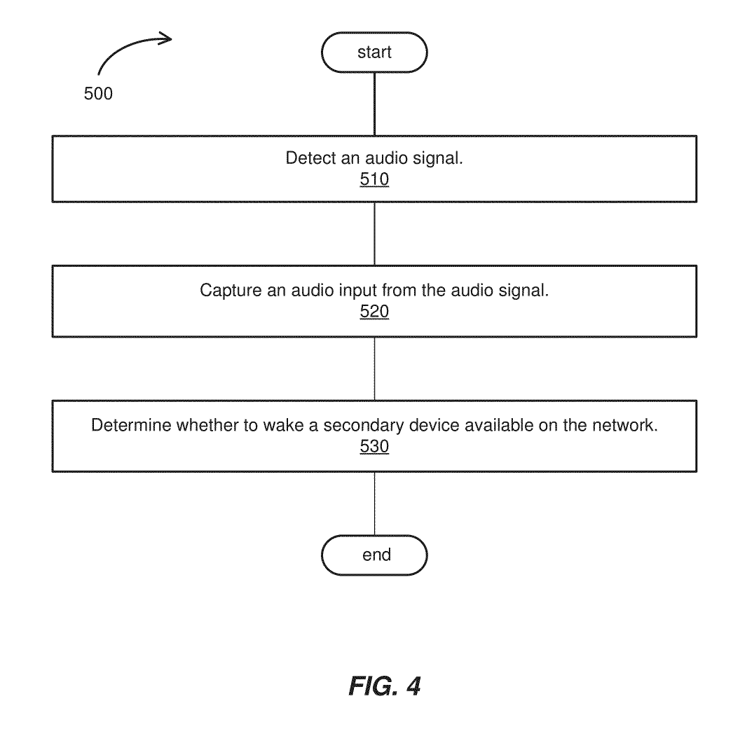

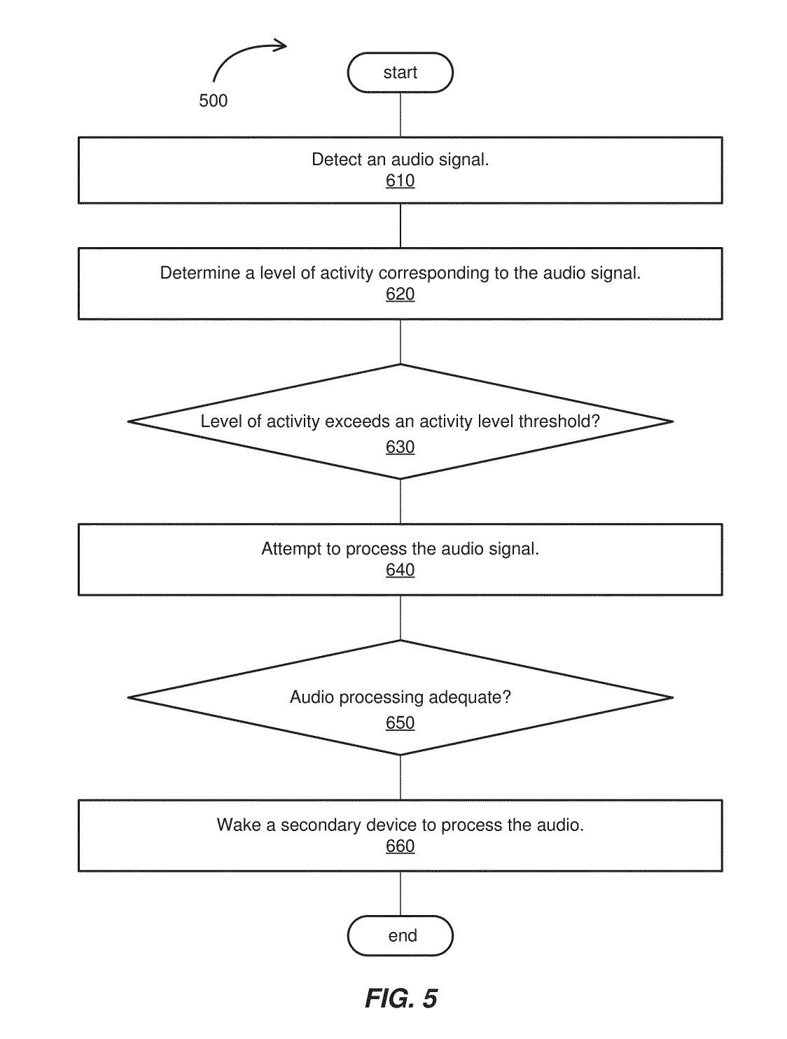

FIGS. 4-5 illustrate example embodiments of logic flows that may be implement by components within the system 1000. The illustrated logic flows may be representative of some or all of the operations executed by one or more embodiments described herein. More specifically, the logic flows may illustrate operations performed by the processor components 110 in executing at least the control routines 121. Although the logic flows are described with reference to FIGS. 1-3, examples are not limited in this context.

Turning more specifically to FIG. 4, a logic flow 500 is depicted. The logic flow 500 may begin at block 510. At block 510, a processor component of a power preferred computing device of an audio processing coordination system (e.g., the processor component 110 of the power preferred computing device 100 of the system 1000) is caused by execution of an audio detector to detect an audio signal. For example, the audio detector 1211 of the control routine 121 may detect the audio signal 400.

Continuing to block 520, the processor component of the power preferred computing device of the audio processing coordination system (e.g., the processor component 110 of the computing device 100 of the system 1000) is caused by execution of an audio recorder to capture an audio input from the audio signal. For example, the audio recorder 1212 of the control routine 121 may generate the audio input 122 by capturing the audio signal 400.

Continuing to block 530, the processor component of the power preferred computing device of the audio processing coordination system (e.g., the processor component 110 of the computing device 100 of the system 1000) is caused by execution of an audio processing coordinator 1214 to determine whether to wake a secondary device available via a network. For example, the audio processing coordinator 1214 of the control routine 121 may determine whether to wake one of the secondary computing devices 200-1 or 200-2.

Turning more specifically to FIG. 5, the logic flow 600 may begin at block 610. At block 610, a processor component of a power preferred computing device of an audio processing coordination system (e.g., the processor component 110 of the computing device 100 of the system 1000) is caused by execution of an audio detector to detect an audio signal. For example, the audio detector 1211 of the control routine 121 may detect the audio signal 400.

Continuing to block 620, the processor component of the power preferred computing device of the audio processing coordination system (e.g., the processor component 110 of the computing device 100 of the system 1000) is caused by execution of a context engine to determine a level of activity corresponding to the power preferred computing device. For example, the context engine 1215 may determine the contextual characteristic 124 based on the sensor reading 123. In particular, the contextual characteristic 124 may in an indication of a level of activity

Continuing to block 630, the processor component of the power preferred computing device of the audio processing coordination system (e.g., the processor component 110 of the computing device 100 of the system 1000) is caused by execution of an audio processing coordinator to determine whether the level of activity exceeds a threshold level of activity. For example, the audio processing coordinator 1214 of the control routine 121 may determine whether the level of activity indicated in the contextual characteristic 124 exceeds a threshold level of activity.

Continuing to block 640, the processor component of the power preferred computing device of the audio processing coordination system (e.g., the processor component 110 of the computing device 100 of the system 1000) is caused by execution of an audio recorder to attempt audio processing of the detected audio signal based on the determination that the activity level does not exceed an activity level threshold. For example, the audio processing coordinator 1214 may cause the audio processor 1215 to attempt to process the audio input 122 (e.g., attempt to apply voice recognition, or the like) and generate the processed audio 127.

Continuing to block 650, the processor component of the power preferred computing device of the audio processing coordination system (e.g., the processor component 110 of the computing device 100 of the system 1000) is caused by execution of an audio processing coordinator to determine whether audio processing of the audio input was adequate. For example, the audio processing coordinator 1214 of the control routine 121 may determine whether the processed audio 127 is adequate. In some embodiments, the processed audio 127 is adequate if voice recognition applied to the audio input 122 was successful.

Continuing to block 660, the processor component of the power preferred computing device of the audio processing coordination system (e.g., the processor component 110 of the computing device 100 of the system 1000) is caused by execution of an audio processing coordinator to wake a secondary device to capture the audio signal and/or perform audio processing on the audio signal based on the determination that the activity level exceeds a threshold activity level or based on the determination that the audio processing was not adequate. For example, the audio processing coordinator 1214 of the control routine 121 may generate the secondary device instructions 126 including an instruction to wake up, capture the audio signal, and/or process an audio input.

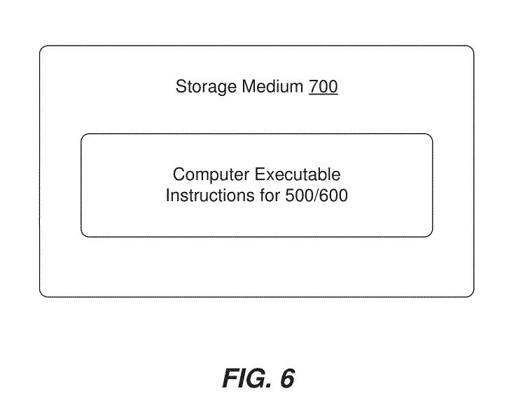

FIG. 6 illustrates an embodiment of a storage medium 700. The storage medium 700 may comprise an article of manufacture. In some examples, the storage medium 700 may include any non-transitory computer readable medium or machine readable medium, such as an optical, magnetic or semiconductor storage. The storage medium 700 may store various types of computer executable instructions, such as instructions to implement logic flows 500, and/or 600. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

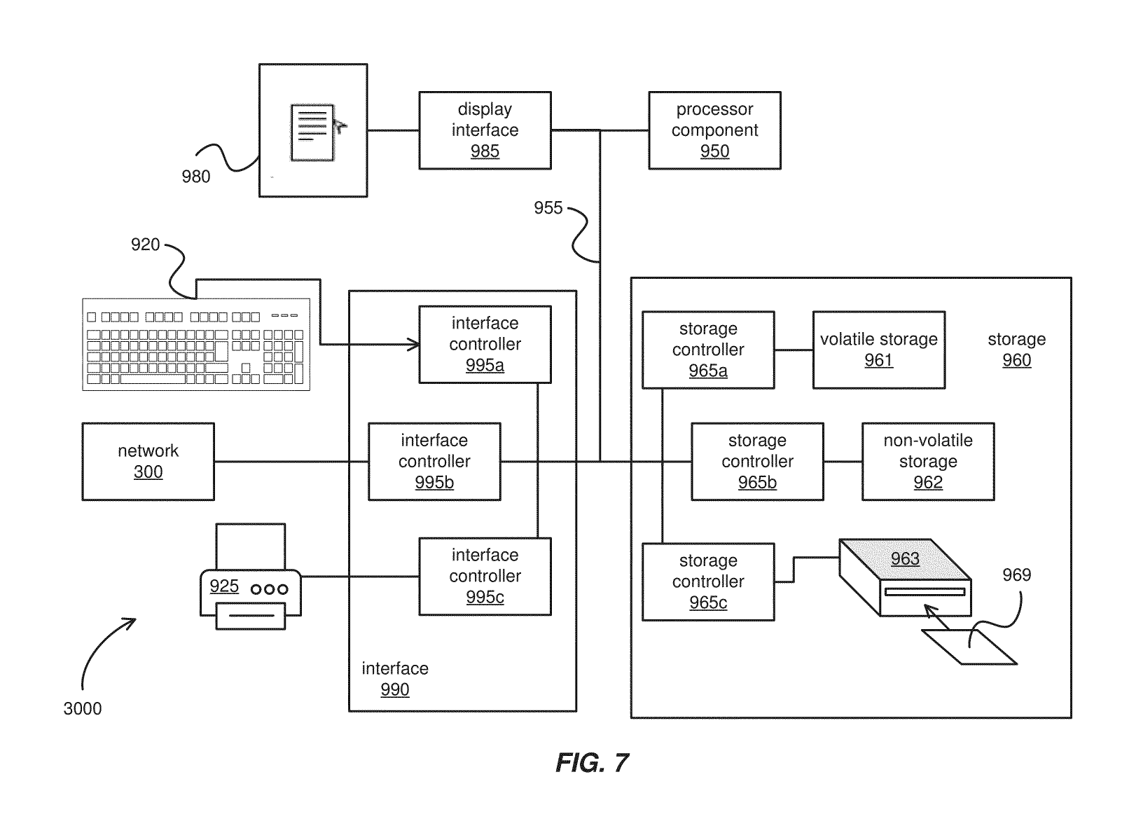

FIG. 7 illustrates an embodiment of an exemplary processing architecture 3000 suitable for implementing various embodiments as previously described. More specifically, the processing architecture 3000 (or variants thereof) may be implemented as part of the computing device 100 and/or 200-a.

The processing architecture 3000 may include various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor component, the processor component itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. A message (including a command, status, address or data message) may be one of such signals or may be a plurality of such signals, and may be transmitted either serially or substantially in parallel through any of a variety of connections and/or interfaces.

As depicted, in implementing the processing architecture 3000, a computing device may include at least a processor component 950, a storage 960, an interface 990 to other devices, and a coupling 955. As will be explained, depending on various aspects of a computing device implementing the processing architecture 3000, including its intended use and/or conditions of use, such a computing device may further include additional components, such as without limitation, a display interface 985.

The coupling 955 may include one or more buses, point-to-point interconnects, transceivers, buffers, crosspoint switches, and/or other conductors and/or logic that communicatively couples at least the processor component 950 to the storage 960. Coupling 955 may further couple the processor component 950 to one or more of the interface 990, the audio subsystem 970 and the display interface 985 (depending on which of these and/or other components are also present). With the processor component 950 being so coupled by couplings 955, the processor component 950 is able to perform the various ones of the tasks described at length, above, for whichever one(s) of the aforedescribed computing devices implement the processing architecture 3000. Coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor component 950 (corresponding to the processor component 110 and/or 210) may include any of a wide variety of commercially available processors, employing any of a wide variety of technologies and implemented with one or more cores physically combined in any of a number of ways.

As previously discussed, the storage 960 (corresponding to the storage 130 and/or 230) may be made up of one or more distinct storage devices based on any of a wide variety of technologies or combinations of technologies. More specifically, as depicted, the storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as possibly including multiple distinct types of storage is in recognition of the commonplace use of more than one type of storage device in computing devices in which one type provides relatively rapid reading and writing capabilities enabling more rapid manipulation of data by the processor component 950 (but possibly using a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of machine-readable storage medium 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage medium 969.

One or the other of the volatile storage 961 or the non-volatile storage 962 may include an article of manufacture in the form of a machine-readable storage media on which a routine including a sequence of instructions executable by the processor component 950 to implement various embodiments may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to storage medium such as a floppy diskette. By way of another example, the non-volatile storage 962 may be made up of banks of solid-state storage devices to store information, such as sequences of instructions, in a manner akin to a compact flash card. Again, it is commonplace to employ differing types of storage devices in a computing device at different times to store executable routines and/or data. Thus, a routine including a sequence of instructions to be executed by the processor component 950 to implement various embodiments may initially be stored on the machine-readable storage medium 969, and the removable media storage 963 may be subsequently employed in copying that routine to the non-volatile storage 962 for longer term storage not requiring the continuing presence of the machine-readable storage medium 969 and/or the volatile storage 961 to enable more rapid access by the processor component 950 as that routine is executed.

As previously discussed, the interface 990 (corresponding to the interface 160 and/or 260) may employ any of a variety of signaling technologies corresponding to any of a variety of communications technologies that may be employed to communicatively couple a computing device to one or more other devices. Again, one or both of various forms of wired or wireless signaling may be employed to enable the processor component 950 to interact with input/output devices (e.g., the depicted example keyboard 920 or printer 925) and/or other computing devices, possibly through a network or an interconnected set of networks. In recognition of the often greatly different character of multiple types of signaling and/or protocols that must often be supported by any one computing device, the interface 990 is depicted as including multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 300 (perhaps a network made up of one or more links, smaller networks, or perhaps the Internet). The interface 995c may employ any of a variety of electrically conductive cabling enabling the use of either serial or parallel signal transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, a camera or camera array to monitor movement of persons to accept commands and/or data signaled by those persons via gestures and/or facial expressions, sounds, laser printers, inkjet printers, mechanical robots, milling machines, etc.

Where a computing device is communicatively coupled to (or perhaps, actually incorporates) a display (e.g., the depicted example display 980, corresponding to the display 150 and/or 250), such a computing device implementing the processing architecture 3000 may also include the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

More generally, the various elements of the computing devices described and depicted herein may include various hardware elements, software elements, or a combination of both. Examples of hardware elements may include devices, logic devices, components, processors, microprocessors, circuits, processor components, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

### Example 1

An apparatus for a power preferred computing device, the apparatus including an audio input device; an audio detector operably coupled to the audio input device, the audio detector to detect an audio signal received by the audio input device; an audio recorder to capture an audio input from the audio signal; a network interface; an audio processing coordinator operably coupled to the network interface, the audio processing coordinator to determine whether to wake a secondary device available via the network interface and determine whether to capture the audio input using the audio recorder.

### Example 2

The apparatus of example 1, further comprising an audio processor configured to process the audio input, wherein the audio processing coordinator further determines whether to process at least a portion of the audio input using the audio processor.

### Example 3

The apparatus of example 2, further comprising a context engine to determine a contextual characteristic corresponding to the audio signal.

### Example 4

The apparatus of example 3, wherein the contextual characteristic includes an indication of the quality of the audio input captured from the audio signal.

### Example 5

The apparatus of example 4, wherein the audio processing coordinator further determines whether the audio quality exceeds an audio quality threshold.

### Example 6

The apparatus of example 5, wherein the audio processing coordinator determines to wake the secondary device based on the determination that the audio quality does not exceed the audio quality threshold.

### Example 7

The apparatus of example 5, wherein the audio processing coordinator determines not to wake the secondary device based on the determination that the audio quality exceeds the audio quality threshold.

### Example 8

The apparatus of example 2, wherein the audio processing coordinator determines to wake the secondary device based on the audio detector detecting the audio signal, wherein waking the secondary device includes instructing the secondary device to capture a secondary audio input from the audio signal.

### Example 9

The apparatus of example 8, wherein the audio processing coordinator further determines whether at least a portion of the audio input could be processed by the audio processor.

### Example 10

The apparatus of example 9, wherein the audio processing coordinator further instructs the secondary device to process at least a portion of the secondary audio input based on the determination that at least a portion of the audio input could not be processed, wherein the portion of the secondary audio input corresponds to the portion of the audio input.

### Example 11

The apparatus of example 2, further comprising a sensor, wherein the contextual characteristic corresponds to an output from the sensor.

### Example 12

The apparatus of example 11, wherein the sensor is an accelerometer and wherein the contextual characteristic is an activity level corresponding to the power preferred device.

### Example 13

The apparatus of example 12, wherein the audio processing coordinator further determines whether the activity level exceeds an activity level threshold.

### Example 14

The apparatus of example 13, wherein the audio processing coordinator determines to wake the secondary device based on the determination that the activity level exceeds the activity level threshold.

### Example 15

The apparatus of example 14, wherein the audio processing coordinator determines to wake the secondary device based on the audio detector detecting the audio signal, wherein waking the secondary device includes instructing the secondary device to capture a secondary audio input from the audio signal.

### Example 16

The apparatus of example 15, wherein the audio processing coordinator further instructs the secondary device to process at least a portion of the secondary audio input based on the determination that the activity level exceeds the activity level threshold.

### Example 17

The apparatus of any of example 1 to 16, wherein the network interface is a personal area network radio.

### Example 18

The apparatus of any of examples 1 to 16, further including a power source; and an energy harvesting device operably coupled to the power source.

### Example 19

The apparatus of example 18, wherein the power source is rechargeable and the energy harvesting devices charges the power source.

### Example 20

The apparatus of example 4, wherein the power preferred computing device is a wearable computing device.

### Example 21

The apparatus of example 20, wherein the power preferred computing device is a shoe, a hat, a necklace, a watch, shirt, jacket, or glasses.

### Example 22

The apparatus of any one of examples 1 to 16, wherein the network interface is a Bluetooth radio, a ZigBee radio, an ANT radio, or an RFID radio.

### Example 23

The apparatus of any one of examples 1 to 16, wherein the power preferred computing device is a non-wearable device.

### Example 24

A method implemented by a power preferred computing device, the method including detecting an audio signal; capturing an audio input from the audio signal; and determining whether to wake a secondary device available via a network.

### Example 25

The method of example 24, further including receiving an output from a sensor; and determining a contextual characteristic corresponding to the audio signal based on the output from the sensor, wherein determining whether to wake the secondary device is based on the contextual characteristic.

### Example 26

The method of example 25, wherein the sensor is an accelerometer and the contextual characteristic is a level of activity, the method further comprising determining whether the level of activity exceeds an activity level threshold, wherein determining to wake the secondary device comprises waking the secondary device based on the determination that the activity level exceeds the activity level threshold.

### Example 27

The method of example 26, wherein waking the secondary device comprises instructing the secondary device to capture a secondary audio input from the audio signal.

### Example 28

The method of example 24, further including determining a quality of the audio input captured from the audio signal; and determining whether the audio quality exceeds an audio quality threshold.

### Example 29

The method of example 28, wherein determining to wake the secondary device comprises waking the secondary device based on the determination that the audio quality does not exceed the audio quality threshold.

### Example 30

The method of example 28, wherein determining to wake the secondary device comprises not waking the secondary device based on the determination that the audio quality exceeds the audio quality threshold.

### Example 31

The method of example 24, wherein determining to wake the secondary device comprise waking the secondary device comprises based on detecting the audio signal, wherein waking the secondary device comprises instructing the secondary device to capture a secondary audio input from the audio signal.

### Example 32

The method of example 31, further comprising processing the audio input; and determining whether at least a portion of the audio input could be processed.

### Example 33

The method of example 33, further comprising instructing the secondary device to process at least a portion of the secondary audio input based on the determination that at least a portion of the audio input could not be processed, wherein the portion of the secondary audio input corresponds to the portion of the audio input.

### Example 34

The method of any one of examples 24 to 33, wherein the secondary device is a first secondary device and wherein determining whether to wake the first secondary device comprises determining whether to wake the first secondary device or whether to wake a second secondary device available via the network.

### Example 35

The method of any one of examples 24 to 33, wherein waking the secondary device comprises transmitting a signal to a passive radio corresponding to the secondary device.

### Example 36

The method of example 35, wherein the passive radio is a Bluetooth radio, a ZigBee radio, an ANT radio, or an RFID radio.

### Example 37

An apparatus comprising means to perform the method of any of examples 24 to 36.

### Example 38

At least one machine readable medium comprising a plurality of instructions that in response to being executed on a power preferred computing device cause the power preferred computing device to perform the method of any of examples 24 to 36.

### Example 39

An apparatus for a personal area network including a processor; a radio operably connected to the processor; one or more antennas operably connected to the radio to transmit or receive wireless signals; an audio input device operable connected to the processor to capture and receive audio signal; and a memory comprising a plurality of instructions that in response to being executed by the processor cause the processor, the radio, or the audio input device to perform the method of any of examples 24 to 36.

What is claimed is:

1. An apparatus for a power preferred computing device comprising:
an audio input device;
an audio detector operably coupled to the audio input device, the audio detector to detect an audio signal received by the audio input device;
an audio recorder to capture an audio input from the audio signal; and
an audio processor configured to process the audio input;
a network interface; and
an audio processing coordinator operably coupled to the network interface, the audio processing coordinator to determine whether to wake a secondary device available via the network interface based on the audio input.

2. The apparatus of claim 1, further comprising:
a context engine to determine a contextual characteristic corresponding to the audio signal,
wherein the contextual characteristic includes an indication of an audio quality of the audio input captured from the audio signal, and
wherein the determination whether to wake the secondary device is based at least in part on the contextual characteristic.

3. The apparatus of claim 2, wherein the audio processing coordinator further determines whether the audio quality exceeds an audio quality threshold.

4. The apparatus of claim 3, wherein the audio processing coordinator determines to wake the secondary device based on the determination that the audio quality does not exceed the audio quality threshold.

5. The apparatus of claim 4, wherein the audio processing coordinator determines not to wake the secondary device based on the determination that the audio quality exceeds the audio quality threshold.

6. The apparatus of claim 1, wherein the audio processing coordinator determines to wake the secondary device based on the audio detector detecting the audio signal, wherein waking the secondary device includes instructing the secondary device to capture a secondary audio input from the audio signal.

7. The apparatus of claim 6, wherein the audio processing coordinator further determines whether at least a portion of the audio input could be processed by the audio processor.

8. The apparatus of claim 7, wherein the audio processing coordinator further instructs the secondary device to process at least a portion of the secondary audio input based on the determination that at least a portion of the audio input could not be processed, wherein the portion of the secondary audio input corresponds to the portion of the audio input.

9. An apparatus for a power preferred computing device comprising:
an audio input device;
an audio detector operably coupled to the audio input device, the audio detector to detect an audio signal received by the audio input device;
an audio recorder to capture an audio input from the audio signal;
an audio processor configured to process the audio input;
a sensor;
a context engine operably coupled to the sensor, the context engine to determine a contextual characteristic corresponding to the audio signal based on output from the sensor;
a network interface; and
an audio processing coordinator operably coupled to the network interface, the audio processing coordinator to determine whether to wake a secondary device available via the network interface based on the contextual characteristic.

10. The apparatus of claim 9, wherein the sensor is an accelerometer and wherein the contextual characteristic is an activity level corresponding to the power preferred device, the audio processing coordinator further determines whether the activity level exceeds an activity level threshold.

11. The apparatus of claim 10, wherein the audio processing coordinator determines to wake the secondary device based on the determination that the activity level exceeds the activity level threshold.

12. The apparatus of claim 10, wherein the audio processing coordinator determines to wake the secondary device based on the audio detector detecting the audio signal, wherein waking the secondary device includes instructing the secondary device to capture a secondary audio input from the audio signal.

13. The apparatus of claim 12, wherein the audio processing coordinator further instructs the secondary device to process at least a portion of the secondary audio input based on the determination that the activity level exceeds the activity level threshold.

14. The apparatus of claim 9, further comprising:
a power source; and
an energy harvesting device operably coupled to the power source.

15. The apparatus of claim 14, wherein the power source is rechargeable and the energy harvesting devices charges the power source.

16. The apparatus of claim 9, wherein the power preferred computing device is a wearable computing device.

17. The apparatus of claim 16, wherein the power preferred computing device is a shoe, a hat, a necklace, a watch, shirt, jacket, or glasses.

18. The apparatus of claim 9, wherein the network interface is a personal area network radio.

19. The apparatus of claim 9, wherein the network interface is a Bluetooth radio, a ZigBee radio, an ANT radio, or an RFID radio.

20. A method implemented by a power preferred computing device, the method comprising:
detecting an audio signal;
capturing an audio input from the audio signal; and
determining whether to wake a secondary device available via a network.

21. The method of claim 20, further comprising:
receiving an output from a sensor; and
determining a contextual characteristic corresponding to the audio signal based on the output from the sensor,
wherein determining whether to wake the secondary device is based on the contextual characteristic.

22. The method of claim 21, wherein the sensor is an accelerometer and the contextual characteristic is a level of activity, the method further comprising determining whether the level of activity exceeds an activity level threshold, wherein determining to wake the secondary device comprises waking the secondary device based on the determination that the activity level exceeds the activity level threshold.

23. The method of claim 22, wherein waking the secondary device comprises instructing the secondary device to capture a secondary audio input from the audio signal.

24. The method of claim 20, further comprising:
determining a quality of the audio input captured from the audio signal; and
determining whether the audio quality exceeds an audio quality threshold.

25. The method of claim 24, wherein determining to wake the secondary device comprises waking the secondary device based on the determination that the audio quality does not exceed the audio quality threshold.
